(19) United States
(12) Patent Application Publication
(10) Pub. No.: US 2026/0068982 A1
(43) Pub. Date: Mar. 12, 2026

(54) BLUETOOTH COUPLED BIKE HELMET

(71) Applicants: AHAAN PANDEY, SAN DIEGO, CA (US); NAOMI LY MEHL, DEL MAR, CA (US); ALEKSANDAR JEREMIC, DAVIS, CA (US); ARAV CHADHA, SAN DIEGO, CA (US); PREETANSHU PANDEY, SAN DIEGO, CA (US)

(72) Inventors: AHAAN PANDEY, SAN DIEGO, CA (US); NAOMI LY MEHL, DEL MAR, CA (US); ALEKSANDAR JEREMIC, DAVIS, CA (US); ARAV CHADHA, SAN DIEGO, CA (US); PREETANSHU PANDEY, SAN DIEGO, CA (US)

(21) Appl. No.: 18/826,482

(22) Filed: Sep. 6, 2024

(51) Int. Cl. A42B 3/30; A42B 3/04; B62M 6/90

(52) U.S. Cl. CPC A42B 3/30; A42B 3/0466; B62M 6/90

(57) ABSTRACT

The Blue Tooth Coupled Bike Helmet couples a battery-powered bicycle or scooter with a helmet via blue tooth or other wireless technology. The device can prevent an electric bicycle, or scooter, from operating unless the rider is wearing the helmet that couples wirelessly to the electric bike. The device includes a microprocessor incorporated into both the helmet and the bicycle, or scooter. Both microprocessors measure orientation, motion, and vibration, and both microprocessors communicate with each other.

### (b) CROSS-REFERENCE TO RELATED APPLICATIONS

This application does not claim priority to any patent application.

### (c) DISCLOSURE REGARDING PRIOR DISCLOSURES BY THE INVENTOR OR A JOINT INVENTOR.

The inventor has not disclosed this invention prior to the filing of this non provisional application.

### (d) BACKGROUND OF THE INVENTION

### (1) Field of the Invention

This device relates to safety devices for bikes, electric bikes, skateboards, scooters, and other mobility and micromobility devices. Specifically, this device can be implemented into any electrically-powered bike or scooter to prevent operation of the bike or scooter unless the rider is wearing a prescribed safety helmet. This device utilizes microprocessors to couple a helmet to an electric bike or scooter.

### (2) Disclosure of the Prior Art

A number of safety devices are disclosed in the prior art for ensuring that a bike rider, which includes but is not limited to a bicycle, electric bicycle, motorcycle, electric scooter, skateboard, micromobility device, or other wheeled vehicle that a rider sits or stands upon while the bike moves relative to the ground, is safe while riding a bike. Most of these devices are helmets designed to protect the rider from suffering impacts to the head upon an accident. Unfortunately, a lot of riders won't wear a helmet despite the risks associated with not doing so. This can expose bike sharing, and scooter sharing, companies to great financial risk if and when a rider not wearing a helmet is involved in an accident. A device is needed that will prevent a rider from being able to operate a bike or scooter unless they are wearing a safety helmet.

US 2020/0297059 A1 (Viner et al.) discloses a system comprising a safety helmet and a shared bicycle or electric bike that utilizes a network to detect the location of the safety helmet relative to the bike. This device allows the network to communicate that a rider is not wearing the approved safety helmet, but this device does not prevent the rider from operating the bike without the safety helmet positioned on the rider's head. The helmet could simply be discarded and the bike operated.

EP 3 313 222 B1 (Mahmoud and Ronnow) discloses a helmet that encourages or controls the use of a helmet while riding a vehicle. The device includes an electronic helmet component associated with an electronic vehicle component that are in wireless communication to each other. Both the helmet and the vehicle include a motion sensor that communicate with a control module electronically. The control module is capable of producing an alert if the helmet is not worn while the vehicle is operating. But, this device specifically does not prevent operation of the vehicle if the helmet is not worn. This device would allow a rider to simply discard the helmet and operate the vehicle.

A device is needed that will prevent the operation of an electric bike motor, or the operation of bike pedals on a non-electric bike, unless the rider is utilizing a safety helmet.

### (e) BRIEF SUMMARY OF THE INVENTION

This device comprises a safety helmet coupled to a bike so that the bike will not operate unless the safety helmet is positioned upon the head of the rider.

### (f) BRIEF DESCRIPTION OF THE DRAWINGS

The invention is described in detail below with reference to the appended drawings. FIGS. 1 through 7 depict the Bluetooth Coupled Bike Helmet.

In the Figures:

FIG. 1 depicts the helmet circuit.

FIG. 2 depicts the circuit design for the helmet.

FIG. 3 shows the bike microcontroller circuit.

FIG. 4 shows the circuit design of the bike.

FIG. 5 shows an alternate circuit design for the bike.

FIG. 6 depicts the circuit integrated to the bike.

FIG. 7 is a flow chart of the helmet coupled to the bike.

### (g) DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an embodiment in the present disclosure, can be, but not necessarily, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same term can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

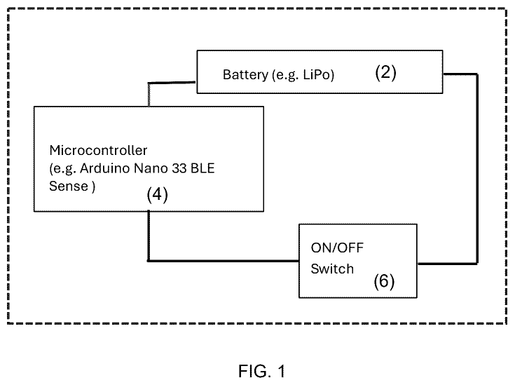

FIG. 1 is an overview of the helmet circuit. The helmet circuit includes battery 2, which may be a LiPo battery, or other suitable battery. Battery 2 powers helmet microcontroller 4, which may be an Arduino Nano 33 BLE Sense Rev2 microcontroller, or any suitable microcontroller with bluetooth and a built-in inertia measuring capacity allowing measurement of orientation, motion and vibrations. Helmet microcontroller 4 includes an antenna function to allow wireless communication between the helmet and the bike, or scooter. Helmet microcontroller 4 is coupled to ON/OFF switch 6 that allows the helmet to be turned off or on by the rider to allow operation of the bike or scooter. The components of the helmet circuit may be mounted inside the helmet so that they do not distract the rider while in use.

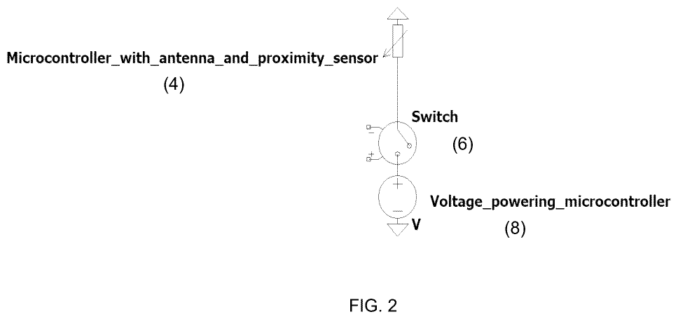

FIG. 2 shows one embodiment of a circuit design for the helmet member. When a rider turns on switch 6, voltage 8 from the battery is transmitted to helmet microcontroller 4.

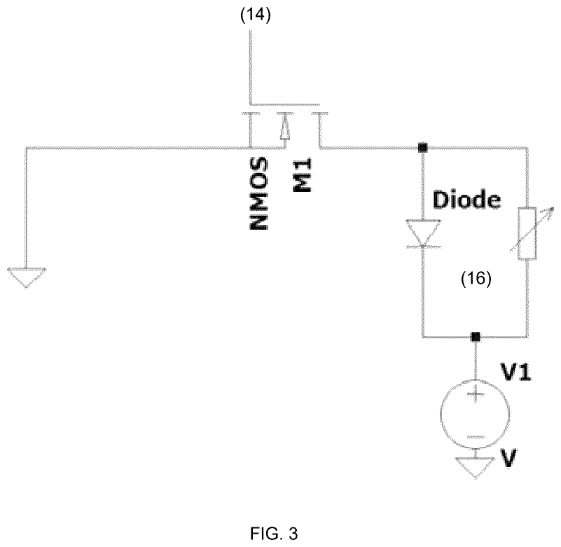

The microcontroller bike circuit is depicted in FIG. 3. The bike microcontroller 14 may be an Arduino Nano 33 BLE microcontroller, or other small, powerful microcontroller with an inertial measurement unit including an accelerometer, a gyroscope, and a magnetometer with multiple-axis resolution. Bike microcontroller 14 receives data from helmet microcontroller 4 (shown in FIG. 1) wirelessly via antenna functionality. Bike microprocessor 14 communicates with bike motor 16 turning bike motor 16 off and on. FIG. 3 shows a diode coupled to bike motor 16 that transmits voltage.

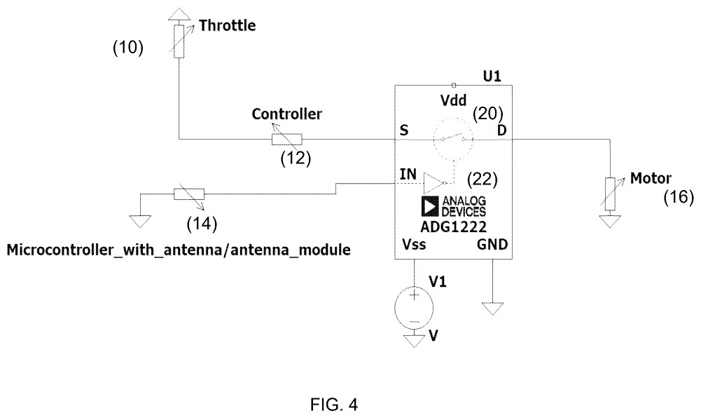

The electromagnetic switch embodiment of the device is shown in FIG. 4. Bike microcontroller 14 receives data from helmet microcontroller 4 (shown in FIG. 2) that connects to throttle 10, which operates bike motor 16. Relay 20, which is positioned between controller 12 and motor 16 acts via an electromagnetic switch. When bike microcontroller 14 receives data that the helmet is on the rider's head, positioned a certain distance from the bike microcontroller 14, the bike microcontroller 14 sends a digital “High” to relay switch input terminal 22. Next, relay switch 20 allows current from the controller 12 to be transmitted to bike motor 16, allowing bike motor 16 to power the bike, or scooter. This embodiment allows the bike to operated only while bike microcontroller 14 is receiving the correct signal from the helmet. The electric bike pedals may still be operational when a rider pumps the pedals with their feet, but the motored operation will be disabled. This prevents a user from being able to operate the bike, or scooter, at the high speeds created by use of motor 16 making the bike safer at lower foot-powered speeds.

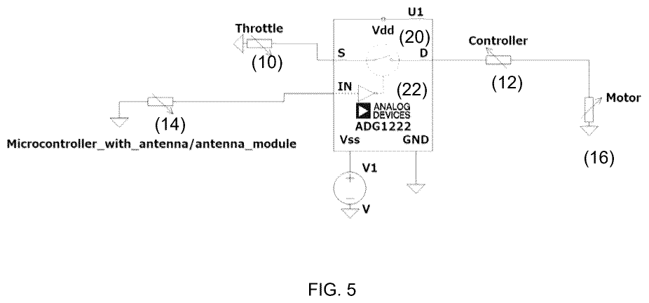

FIG. 5 depicts an alternate electromagnetic switch embodiment. This embodiment locates the relay switch input terminal 22 and the relay switch 20 between throttle 10 and controller 12. As noted for the embodiment shown in FIG. 4, motor 16 will not operate unless the correct signal from the helmet is received by bike microcontroller 14.

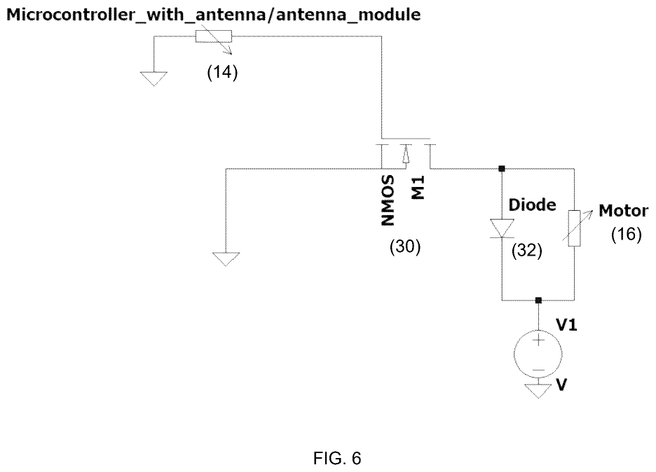

FIG. 6 shows the electrical circuit integrated into the bike, or scooter. Bike microcontroller 14 with the antenna module is attached to the gate of an CMOS 30, that is acting in place of a switch. When bike microcontroller 14 produces a DC “High” signal, usually 3-5 volts), CMOS 30 is activated into the triode or saturation region. The circuit is connected to diode 32 limiting the total voltage on motor 16. Motor 16 is modeled by a resistive element. When bike microcontroller 14 is “ON”, CMOS 30 allows current to conduct from its source to drain the right side of CMOS 30, and vice versa.

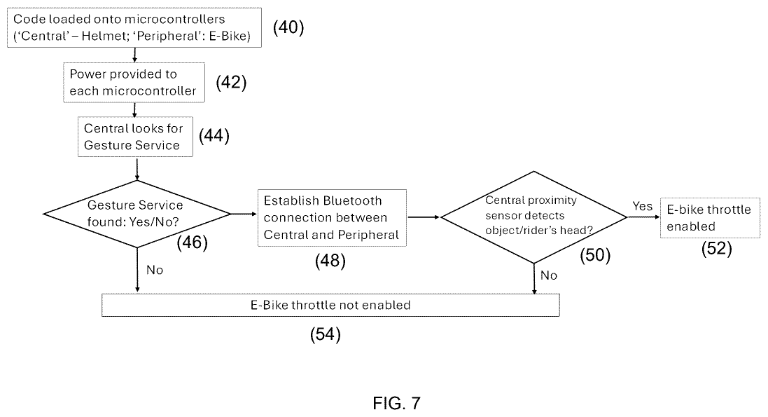

A flow chart of this device is depicted in FIG. 7. Code is loaded onto both the helmet microcontroller 4 (Central) and the bike microcontrollers (Peripheral) at step 40. At step 42, power is provided to microcontrollers 4 and 14. Next, Central looks for Gesture Service at step 44. If Gesture Service is not found at step 46, then bike throttle 10 is not enabled at step 54. If Gesture Service is found at step 46, then a bluetooth connection is established between the helmet (Central) and bike microcontroller (Peripheral), 4 and 14 respectively at step 48. Then the proximity of the helmet to the bike is detected at step 50. If the helmet is properly located at the rider's head at step 50, then throttle 10 is enabled and the bike motor powers the bike. If the helmet is not positioned correctly at step 50, then throttle is not enabled at step 54.

1). An apparatus comprising:
a helmet worn about the head of a bicycle rider,
a first microcontroller, wherein the first microcontroller is coupled to the helmet, wherein the first microcontroller measuring orientation, motion and vibration of the helmet, wherein the first microcontroller includes an antenna that wireless connects the helmet to a second microcontroller,
a bicycle that is battery powered,
an electromagnetic switch positioned on the bicycle,
wherein the electromagnet switch connects to a throttle that operates a battery-powered motor, wherein the motor powers rotation of wheels on the bicycle when the helmet is positioned upon the rider's head; and
a second microcontroller measuring orientation, motion and vibration of the bicycle, wherein the second microcontroller includes an antenna that wirelessly connects the bicycle to the first microcontroller.

2). The apparatus of claim 1, further comprising a switch on the helmet that allows the rider to turn the first microprocessor off or on.

3). An apparatus comprising:
a helmet worn about the head of a scooter rider,
a first microcontroller, wherein the first microcontroller is coupled to the helmet, wherein the first microcontroller measuring orientation, motion and vibration of the helmet, wherein the first microcontroller includes an antenna that wireless connects the helmet to a second microcontroller,
a scooter that is battery powered,
an electromagnetic switch positioned on the scooter,
wherein the electromagnet switch connects to a throttle that operates a battery-powered motor, wherein the motor powers rotation of wheels on the scooter when the helmet is positioned upon the rider's head; and
a second microcontroller measuring orientation, motion and vibration of the scooter, wherein the second microcontroller includes an antenna that wirelessly connects the scooter to the first microcontroller.

4). The apparatus of claim 3, further comprising a switch on the helmet that allows the rider to turn the first microprocessor off or on.
